(19) United States
(12) Patent Application Publication
(10) Pub. No.: US 2007/0040655 A1
(43) Pub. Date: Feb. 22, 2007

(54) Wireless electronic device with a kinetic-energy-to-electrical-energy converter

(76) Inventors: Thomas H. Lee, Burlingame, CA (US); Arthur J. Collmeyer, Incline Village, NV (US); Dickson T. Wong, Burlingame, CA (US)

Correspondence Address: BRINKS HOFER GILSON & LIONE, P.O. BOX 10395, CHICAGO, IL, 60610, US

(21) Appl. No.: 11/498,917

(22) Filed: Aug. 3, 2006

Related U.S. Application Data
(60) Provisional application No. 60/705,311, filed on Aug. 4, 2005.
(60) Provisional application No. 60/705,756, filed on Aug. 5, 2005.

(51) Int. Cl. H04Q 5/22

(52) U.S. Cl. 340/10.1; 455/343.1; 340/572.1; 340/5.64; 340/10.34

(57) ABSTRACT

A wireless electronic device with a kinetic-energy-to-electrical-energy converter is disclosed. In one embodiment, the wireless electronic device comprises a control mechanism, a kinetic-energy-to-electrical-energy converter, and a movable user interface element, wherein movement of the movable user interface element provides both signal information to the control mechanism and kinetic energy to the kinetic-energy-to-electrical-energy converter. The kinetic-energy-to-electrical-energy converter converts kinetic energy provided by movement of the movable user interface element to electrical energy and provides the electrical energy to the wireless electronic device. In one embodiment, the wireless electronic device takes the form of a radio frequency identification (RFID) device with multiple identifiers and a control input.

### CROSS-REFERENCE TO RELATED APPLICATIONS

This application claims the benefit of U.S. Provisional Application No. 60/705,311, filed Aug. 3, 2005, and of U.S. Provisional Application No. 60/705,756, filed Aug. 5, 2005, each of which is hereby incorporated by reference.

### BACKGROUND

Wireless technology has enhanced the convenience and functionality of existing applications as well as enabled a number of new applications. One major advantage of wireless technology is the un-tethering of cords and wires of electronic devices, such as cordless phones, PC peripherals, and remote controls.

FIG. 1 is an illustration of a prior art wireless electronic device 100. The wireless electronic device 100 comprises a movable user interface element 105. A user 110 provides a force 115 to move the movable user interface element 105 (e.g., pressing a button). The movement of the movable user interface element 105 provides signal information to a control mechanism of the wireless electronic device 100. The wireless electronic device 100 contains an internal energy storage device, such as a battery, which serves as a power source for the wireless electronic device 100. External power source 120 delivers energy 125 to recharge the internal energy storage device. External power source 120 can also be used to directly provide power for the operation of the electronic device 100.

Greater portability of wireless technology brings other challenges. Powering these devices presents major design considerations of these products. Many wireless electronic devices employ a battery as a power source. The battery may be either non-rechargeable or rechargeable. In the case of devices using non-rechargeable batteries, there is user inconvenience when the batteries need to be replaced. In the case of rechargeable batteries, there is user inconvenience when an external power source needs to be connected in order to recharge the batteries.

Energy scavenging is a method in which energy from the surrounding environment is collected in order to power a wireless electronic device. For example, a solar cell can be employed to convert photonic energy to electrical energy in order to charge the batteries in a wireless electronic device. As another example, a piezoelectric device can be used to convert mechanical vibrations from the environment to electrical power in order to charge the batteries in a wireless electronic device.

### BRIEF DESCRIPTION OF THE DRAWINGS

FIG. 1 is an illustration of a prior art wireless electronic device.

FIG. 2 is an illustration of a wireless electronic device of an embodiment.

FIG. 3 is an illustration of components of a wireless electronic device of an embodiment.

FIG. 4 is an illustration of a kinetic-energy-to-electrical-energy converter of an embodiment.

FIG. 5 is a multi-ID RFID device of an embodiment that uses a kinetic-energy-to-electrical-energy converter.

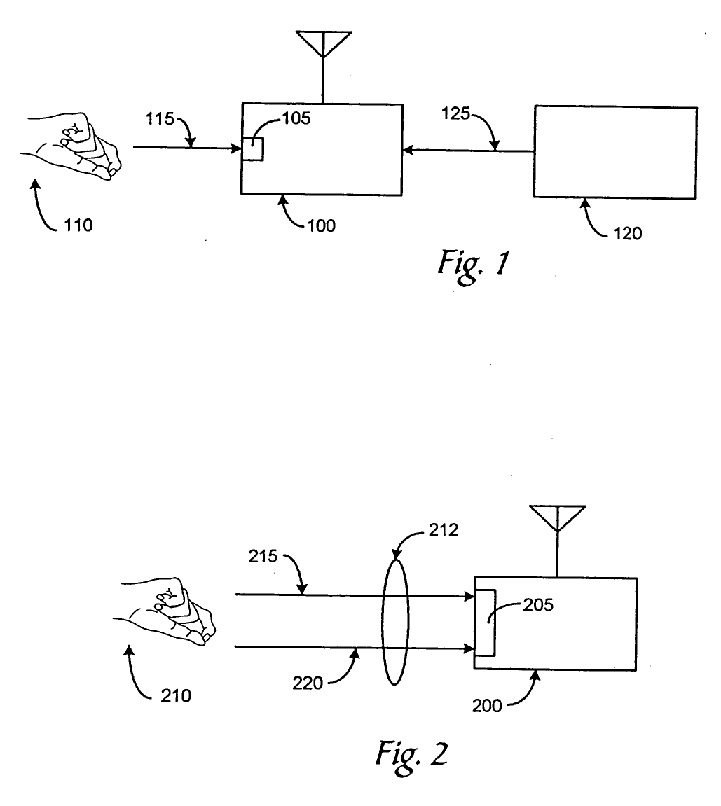

### DETAILED DESCRIPTION OF THE PRESENTLY PREFERRED EMBODIMENTS

By way of overview, the embodiments presented herein relate to a wireless electronic device that uses kinetic energy that is generated when a user moves a movable user interface element to provide power to the device. This maximizes user convenience without altering existing user behavior since users exert mechanical force as a method of inputting data, requesting a desired outcome, or otherwise interacting with a wireless electronic device.

Turning now to the drawings, FIG. 2 is an illustration of a wireless electronic device 200 of an embodiment. The wireless electronic device 200 comprises a movable user interface element 205. A user 210 provides a force 212 to move the movable user interface element 205. For example, the movable user interface element 205 can be a button on a keypad, and the user 210 provides the force 212 to press the button. As shown diagrammatically in FIG. 2, in this embodiment, the force 212 serves two purposes: (1) to provide input 215 to the wireless electronic device 200 as a way of the user's normal behavior in interfacing with the device 200 (e.g., pressing a button on a cell phone) and (2) to provide kinetic energy 220, which is converted to provide power for the device 200. In other words, the force 212 that is applied by the user 210 during normal interface behavior with the device 200 is used to provide power for the operation of the device.

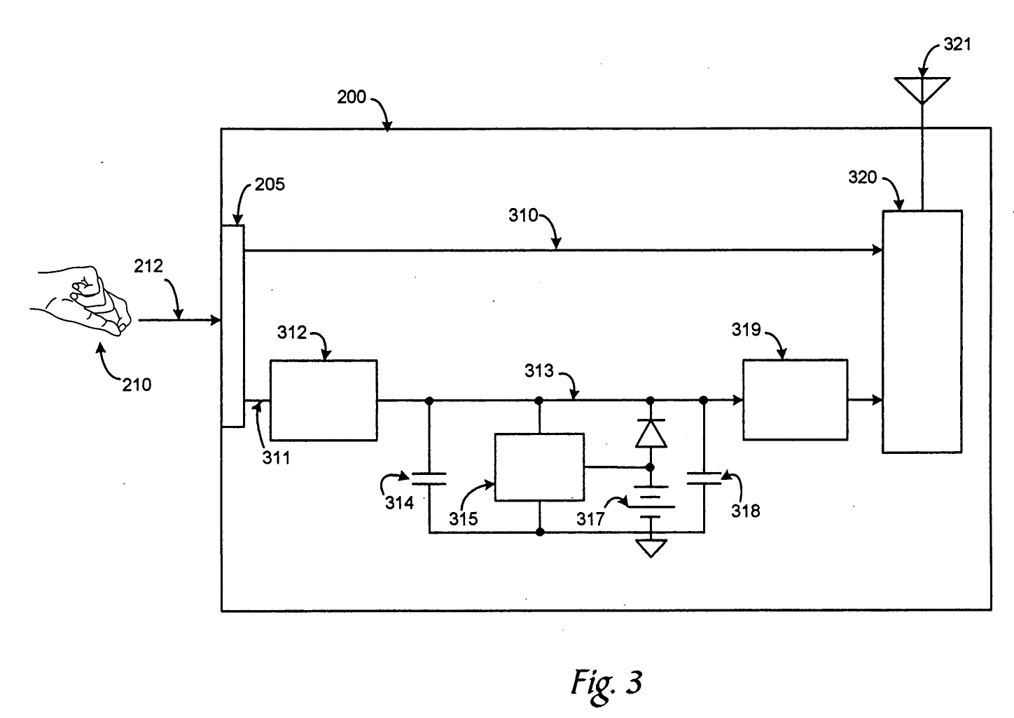

FIG. 3 is an illustration of exemplary components that can be used in the wireless electronic device 200. As shown in FIG. 3, the force 212 applied by the user 210 to move the movable user interface element 205 provides signal information 310 to a control mechanism 320 of the device 200. The term “control mechanism” broadly refers to any mechanism of the device 200 that responds to signal information generated from the movement of the movable user interface element 205. For example, if the movable user interface element 205 is a “send” button on a cell phone, the control mechanism 320 can respond to the signal information generated when the send button is pushed by transmitting a dialed number to a cellular phone network via the antenna 321. It should be noted that a “control mechanism” can perform functions that are not tied to signal information generated from the movement of a movable user interface element. For example, the control mechanism 320 can receive information via the antenna 321 independent of whether the movable user interface element 205 is moved (e.g., when a cell phone receives an incoming call, that function is independent of a user pressing a button).

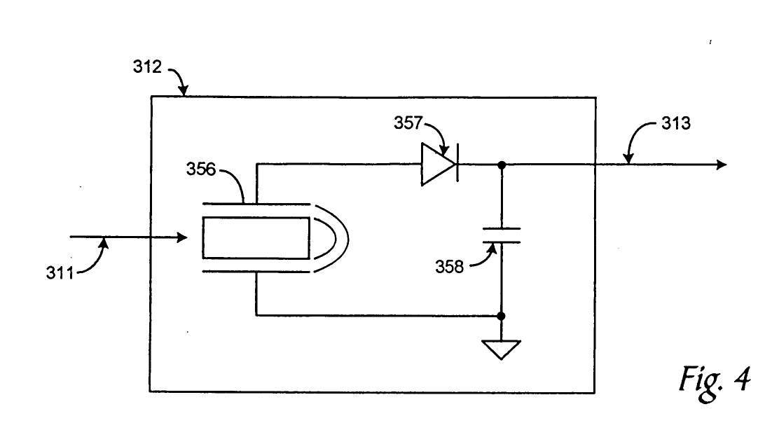

As noted above, in addition to generating signal information 310, movement of the movable user interface element 205 also provides kinetic energy 311 to a kinetic-energy-to-electrical-energy converter 312. As used herein, a “kinetic-energy-to-electrical-energy converter” refers to any device that converts kinetic energy to electrical energy. For example, the kinetic-energy-to-electrical-energy converter 312 can contain a coil and a magnet, with the movement of the movable user interface element 205 causing the magnet to pass near or through the coil or causing the coil to pass near or over the magnet. As another example, the kinetic-energy-to-electrical-energy converter 312 can comprise a piezoelectric device. Other types of the kinetic-energy-to-electrical-energy converters can be used. An example in which the kinetic-energy-to-electrical-energy converter 312 comprises a piezoelectric device is illustrated in FIG. 4. As shown in FIG. 4, the kinetic-energy-to-electrical-energy converter 312 comprises a piezoelectric device 356, a rectifier 357, and a capacitor 358. In operation, kinetic energy 311 provided when the movable user interface element 205 is moved excites the piezoelectric device 356. When the piezoelectric device 356 is in an excited state, it produces electrical energy 313, which is filtered via the rectifier 357 and the capacitor 358.

Returning to FIG. 3, the electrical energy 313 produced by the kinetic-energy-to-electrical-energy converter 312 is provided to a power regulator 319, which provides regulated power to the control mechanism 320. In this embodiment, the control mechanism 320 uses the signal information 310 and the regulated power from the power regulator 319 to transmit a signal via the antenna 321 to affect an outcome desired by the user 210. In other embodiments, the control mechanism 320 uses the signal information 310 and the regulated power from the power regulator 319 to perform a function that does not involve the antenna 321 (e.g., storing inputted name and phone number information in memory internal to the device 200).

As shown in FIG. 3, the wireless electronic device 200 also comprises energy storage devices such as capacitors 314, 318 and/or a rechargeable battery 317 controlled by a battery charger 315. Accordingly, the electrical energy 313 produced by the kinetic-energy-to-electrical-energy converter 312 can be used to contemporaneously power the device 200 or can be stored for later use. The phrase “providing electrical energy to the wireless electronic device” is intended to cover either situation.

It should be noted that a wireless electronic device can take any suitable form. For example, a wireless electronic device can be a computer pointing device such as a mouse or track ball, a light switch, an exercise apparatus, a game controller (e.g., a joystick), a toy (e.g., a remote-controlled car), a remote control for a home appliance (e.g., a TV or stereo remote control or a garage-door opener), a cell phone, a portable computing device (e.g., a wireless laptop or a Blackberry™ wireless handheld device), or a radio frequency identification (RFID) device. A movable user interface element can also take any suitable form. For example, a movable user interface element can be a key of keypad, a key of a keyboard, a joystick, a wheel (such as a wheel on a Blackberry™ wireless handheld device), a ball, a switch (e.g., an on/off switch or a spring-loaded toggle switch), a button, a slide, a knob, and a pivotable element (e.g., one of the covers of a flip phone). It should also be noted that while a single movable user interface element was shown in the drawings for simplicity, a wireless electronic device can have a plurality of movable user interface elements. For example, each key on a standard 12-key keypad on a cell phone and the pivotable cover of the phone can be separate movable user interface elements that provide kinetic energy.

It should also be noted that the kinetic-energy-to-electrical-energy converter 312 can be the sole energy source for the device 200 or be one of several energy sources for the device 200. For example, if the device 200 takes the form of an RFID tag, the device 200 can be powered just by the electrical energy from the kinetic-energy-to-electrical-energy converter 312 or also from energy received by an energy collection element.

As noted above, a wireless electronic device can take the form of a RFID device. A convention RFID tag is passive and does not use a battery. Instead, the passive RFID tag contains an energy collection element that collects energy transmitted via wireless means by an external source. The collected energy is used to power a radio frequency (RF) transmitter to transmit a unique identifier of the RFID tag. Because of the limited range of passive RFID tags, semi-active RFID tags, incorporating a small battery to boost the range of the RF transmitter, have been proposed. In a semi-active RFID tag, energy collected by the energy collection element of the tag can be applied to initiate transmission of a unique identifier utilizing the energy stored in the battery.

While passive RFID tags are practical in supply chain applications where the life of the RFID tag is relatively short, passive RFID tags are not as practical in applications where the RFID tag is intended to be used for a relatively long period of time. For example, “Radio Frequency Identification (RFID) Device with Multiple Identifiers and a Control Input,” U.S. patent application Ser. No. ______ (attorney docket no. 13111/4, filed herewith), which is assigned to the assignee of the present patent application and is hereby incorporated by reference, describes RFID devices that contain multiple identifiers and can extend the application of RFID technology beyond conventional supply chain and access control applications. As a non-limiting example, a multi-ID RFID tag can be used as a wireless light switch, wherein one unique ID corresponds to the light being set to “ON”, and another unique ID corresponds to the light being set to “OFF”. Combination of ID's for more than two states can be employed. For example, a list of three IDs results in six illumination levels, in addition to ON and OFF. In such an application, a control input to the RFID device (e.g., a manually-operated switch) is used by the user to select an illumination level. Since the RFID tag in this application is intended to be used for a long period of time, the finite life of a battery of a semi-active RFID tag would introduce an undesirable ongoing maintenance requirement.

When a movable user interface element (e.g., a manually-operated switch) is used to select a set of multiple identifiers in a multi-ID RFID device, the above embodiments can be employed to use the resulting kinetic energy to provide electrical energy to the multi-ID RFID device. For example, when the multi-ID RFID device is used in a wireless light switch, power of the wireless light switch is provided by the habitual, normal operational behavior of the user (i.e., flipping the switch on and off). This allows a passive multi-ID tag to achieve the range of a semi-active RFID tag without the ongoing maintenance requirement associated with batteries. Alternatively, the power provided by the habitual, normal operational behavior of the user can be used to supplement or recharge a battery in a semi-passive multi-ID tag.

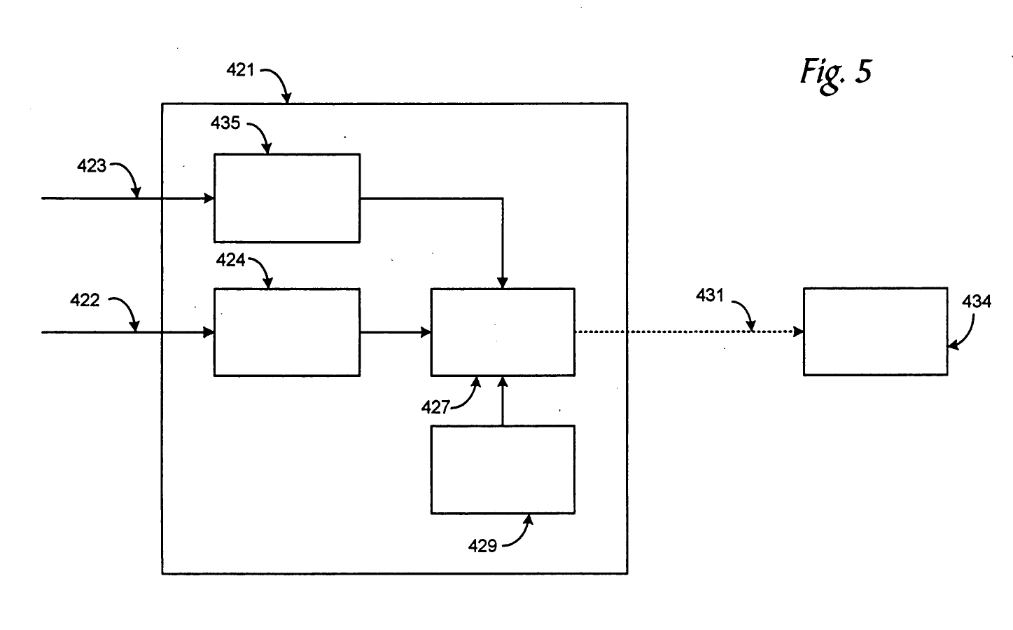

FIG. 5 is an illustration of a multi-ID RFID device 421 that uses a kinetic-energy-to-electrical-energy converter. Such a device is sometimes referred to herein as a “mechanically-energized identification (MEID) transmitter.” As shown in FIG. 5, the MEID transmitter 421 comprises a control input 422 that determines which of a set of selectable ID's will be transmitted on the energizing of MEID transmitter 421 by mechanical input 423 or at the initiation of control mechanism 424. The control mechanism 424 configures the ID transmitter 427 to transmit the ID or ID's corresponding to the selection implicit in the control input 422. The control mechanism 424 may also initiate transmission of the selected ID or IDs if energy is available from an earlier energizing of the MEID transmitter 421 by mechanical input 423. The ID list 429 provides a list of IDs to be transmitted via the ID transmitter 427. Control input 422 could take the form of a manually-operated mechanical switch or an electrical signal. Mechanical input 423 could take the form of a manually-operated switch. Both the control input 422 and the mechanical input 423 could be combined into a single manual operation, such as toggling a spring-loaded toggle switch or pressing a spring-loaded button switch. Energy for the MEID transmitter 421 is provided by the energy conversion element 435 (i.e., the kinetic-energy-to-electrical-energy converter), which converts the energy in mechanical input 423 to electrical energy. As noted above, the energy conversion element 435 (kinetic-energy-to-electrical-energy converter) converts kinetic energy to electrical energy using various techniques. By way of non-limiting example, kinetic energy can be converted to electrical energy by the stimulation of a piezoelectric device or by the creation of a magnetic field. The energy conversion element 435 either transfers the electrical energy to ID transmitter 427 or stores it for use by ID transmitter 427 as directed by control mechanism 424. The ID signal 429 is transmitted by the ID transmitter 427 via wireless means 431 to the ID receiver 434.

It should be noted that FIG. 5 is just one example, and the kinetic energy conversion technique described herein can be used with other embodiments shown and described in the above-referenced patent application. For example, the RFID device can contain several RFID tags (with the control mechanism providing enable/disable signals to the RFID tags or to RF shields to control which tags send their identifiers), as shown in FIGS. 3 and 4 in the above-referenced patent application. Each of the RFID tags in the device can contain their own energy collection element (as shown in FIGS. 3 and 4 in the above-referenced patent application), or a common energy collection element can be used (as shown in FIG. 5 in the above-referenced patent application). The kinetic energy conversion technique described herein can also be used with a semi-active multi-ID tag (as shown in FIG. 7 in the above-referenced patent application), as well as with an actuator to implement wireless switching of an electrical circuit, with or without the use of multiple energy transmission elements and a network of intercommunicating actuators with intercommunicating ID transceivers, as shown in FIGS. 8-11 in the above-referenced patent application).

It is intended that the foregoing detailed description be understood as an illustration of selected forms that the invention can take and not as a definition of the invention. It is only the following claims, including all equivalents, that are intended to define the scope of this invention.

What is claimed is:

1. A wireless electronic device comprising:
a control mechanism;
a kinetic-energy-to-electrical-energy converter; and
a movable user interface element, wherein movement of the movable user interface element provides both signal information to the control mechanism and kinetic energy to the kinetic-energy-to-electrical-energy converter;
wherein the kinetic-energy-to-electrical-energy converter converts kinetic energy provided by movement of the movable user interface element to electrical energy and provides the electrical energy to the wireless electronic device.

2. The wireless electronic device of claim 1, wherein the kinetic-energy-to-electrical-energy converter comprises a coil and a magnet.

3. The wireless electronic device of claim 1, wherein the kinetic-energy-to-electrical-energy converter comprises a piezoelectric device.

4. The wireless electronic device of claim 1 further comprising a rechargeable battery, wherein the kinetic-energy-to-electrical-energy converter provides electrical energy to recharge the rechargeable battery.

5. The wireless electronic device of claim 1 further comprising a capacitor, wherein the capacitor stores electrical energy provided by the kinetic-energy-to-electrical-energy converter.

6. The wireless electronic device of claim 1, wherein the movable user interface element comprises an input device of a radio frequency identification (RFID) device.

7. The wireless electronic device of claim 1, wherein the wireless electronic device comprises a device selected from the group consisting of a computer pointing device, a mouse, a track ball, a light switch, an exercise apparatus, a game controller, a joystick, a toy, a remote control for a home appliance, a remote control for a TV, a remote control for a stereo, a garage-door opener, a cell phone, a portable computing device, or a radio frequency identification (RFID) device.

8. The wireless electronic device of claim 1, wherein the movable user interface element comprises a movable user interface element selected from the group consisting of a key of keypad, a key of a keyboard, a joystick, a wheel, a ball, a switch, a button, a slide, a knob, and a pivotable element.

9. A radio frequency identification (RFID) device comprising:
a kinetic-energy-to-electrical-energy converter;
a radio frequency (RF) transmitter;
a plurality of identifiers;
a movable user interface element operative to provide a selection indicative of a set of the plurality of identifiers; and
a control mechanism operative to cause the RF transmitter to transmit the set of identifiers indicated by the selection;
wherein movement of the movable user interface element provides both signal information to the control mechanism and kinetic energy to the kinetic-energy-to-electrical-energy converter, and wherein the kinetic-energy-to-electrical-energy converter converts kinetic energy provided by movement of the movable user interface element to electrical energy and provides the electrical energy to the RFID device.

10. The RFID device of claim 9, wherein the RFID device comprises a single RFID tag.

11. The RFID device of claim 9, wherein the RFID device comprises a plurality of RFID tags, each RFID tag storing a respective one of the plurality of identifiers.

12. The RFID device of claim 9, wherein the set of identifiers comprises a single identifier.

13. The RFID device of claim 9, wherein the set of identifiers comprises more than one identifier.

14. The RFID device of claim 9 further comprising an energy collection element, and wherein the RF transmitter transmits the set of identifiers in response to energy received by the energy collection element.

15. The RFID device of claim 9, wherein the RF transmitter transmits the set of identifiers in response to movement of the movable user interface element.

16. The RFID device of claim 9 further comprising a battery in communication with the RF transmitter.

17. A radio frequency identification (RFID) device comprising:
a kinetic-energy-to-electrical-energy converter;
a plurality of RFID tags storing a plurality of identifiers, wherein each of the plurality of RFID tags comprises a respective radio frequency (RF) transmitter and stores a respective one of the plurality of identifiers;
a movable user interface element operative to provide a selection indicative of a set of the plurality of identifiers; and
a control mechanism operative to cause the RF transmitter(s) of the RFID tag(s) storing the set of identifiers to transmit the set of identifiers;
wherein movement of the movable user interface element provides both signal information to the control mechanism and kinetic energy to the kinetic-energy-to-electrical-energy converter, and wherein the kinetic-energy-to-electrical-energy converter converts kinetic energy provided by movement of the movable user interface element to electrical energy and provides the electrical energy to the RFID device.

18. The RFID device of claim 17, wherein the control mechanism is operative to cause the RF transmitter(s) of the RFID tag(s) to transmit the set of identifiers by providing signals to enable the RF transmitter(s) of the RFID tag(s).

19. The RFID device of claim 17, wherein each of the plurality of RFID tags comprises a respective energy collection element, wherein the RFID device further comprises a plurality of RF shields for the plurality of energy collection elements, and wherein the control mechanism is operative to cause the RF transmitter(s) of the RFID tag(s) to transmit the set of identifiers by providing signals to disable the RF shield(s) for each of the RFID tag(s) storing the set of identifiers.

20. The RFID device of claim 17 further comprising a common energy collection element shared by the plurality of RFID tags.

21. The RFID device of claim 17, wherein the set of identifiers comprises a single identifier.

22. The RFID device of claim 17, wherein the set of identifiers comprises more than one identifier.

23. The RFID device of claim 17, wherein each RFID tag further comprises an energy collection element, and wherein an RF transmitter of an RFID tag transmits the identifier of the RFID tag in response to energy received by the energy collection element.

24. The RFID device of claim 17, wherein an RF transmitter of an RFID tag transmits the identifier of the RFID tag in response movement of the movable user interface element.
